(19) United States
(12) Patent Application Publication
(10) Pub. No.: US 2016/0286776 A1
(43) Pub. Date: Oct. 6, 2016

(54) Chum Sink

(71) Applicant: Cory Kato, Flagler Beach, FL (US)

(72) Inventor: Cory Kato, Flagler Beach, FL (US)

(21) Appl. No.: 15/078,123

(22) Filed: Mar. 23, 2016

Related U.S. Application Data
(60) Provisional application No. 62/142,040, filed on Apr. 2, 2015.

(51) Int. Cl. A01K 97/02; B63B 35/14; A01K 99/00

(52) U.S. Cl. CPC A01K 97/02; A01K 99/00; B63B 35/14

(57) ABSTRACT

A chum sink for use with an anchor line extending from a boat to an anchor includes a weight, a chumming device and a depth line. The weight is selectively attachable to the anchor line. The chumming device is attached to the weight and is configured to hold chum therein and to disperse chum when the chumming device is in water. The depth line is attached to the weight. The depth line is configured to lower the weight along the anchor line so that the chumming device is lowered to a desired depth, so that the chumming device is held by the weight up-current from the boat at the desired depth and so that the chumming device disperses chum at the desired depth in the water and so that dispersed chum is carried down-current in the direction of the boat.

### CROSS-REFERENCE TO RELATED APPLICATION(S)

This application claims the benefit of US Provisional Patent Application Ser. No. 62/142,040, filed Apr. 2, 2015, the entirety of which is hereby incorporated herein by reference.

### BACKGROUND OF THE INVENTION

1. Field of the Invention

The present invention relates generally to an apparatus for fishing and in particular, a chum delivery system for fishing and a method of fishing using chum.

2. Description of the Related Art

Chum is a type of bait that usually includes fish parts (e.g., entrails, fins, etc.) that are left over after fish are cleaned. Chum is frequently dispersed in water to attract game fish to a desired strike zone under a boat. In one method of using chum, a bucket of chum is poured into the water from a fishing boat. The chum disperses and attracts fish to the area into which the chum is dispersing. Sometimes, chum is placed in a porous chum bag or other chum dispersing device, which is lowered from the boat into the water. In both cases, any currents in the water will tend to carry the chum down-current from the place where it is placed in the water. If the boat is anchored to a spot, the chum will typically drift outside the desired strike zone in which fishing lines from the boat are placed. Also, there is little control as to the depth at which the chum drifts with such methods.

Therefore, there is a need for a chum delivery system that disperses chum up-current from the desired strike zone. There is also a need for a system that controls the depth at which chum is dispersed.

### SUMMARY OF THE INVENTION

The disadvantages of the prior art are overcome by the present invention which, in one aspect, is a chum sink for use with an anchor line extending from a boat to an anchor. The chum sink includes a weight, a chumming device and a depth line. The weight is selectively attachable to the anchor line. The chumming device is attached to the weight and is configured to hold chum therein and to disperse chum when the chumming device is in water. The depth line is attached to the weight. The depth line is configured to lower the weight along the anchor line so that the chumming device is lowered to a desired depth, so that the chumming device is held by the weight up-current from the boat at the desired depth and so that the chumming device disperses chum at the desired depth in the water and so that dispersed chum is carried down-current in the direction of the boat.

In another aspect, the invention is a fishing apparatus that includes a boat secured to a floor of a body of water by an anchor that is secured to the boat by an anchor line. The boat is driven to a down-current position from the anchor by a current in the body of water. A weight is secured to the anchor line. A chumming device is attached to the weight. The chumming device is configured to hold chum therein and to disperse chum when the chumming device is in the water so that the chum moves down-current from the chumming device toward and area below the boat. A depth line is attached to the weight. The depth line is configured to lower the weight along the anchor line so that the chumming device is lowered to a desired depth.

In yet another aspect, the invention is a method of dispersing chum in water from an anchor line attached to an anchor and extending from a boat in water, in which the chum is placed in a chumming device. A weight is attached to the anchor line. The chumming device is attached to the weight. The weight and the chumming device are lowered along the anchor line to a desired depth so that chum is dispersed from the chumming device at the desired depth and so that the chum moves down-current from the chumming device in a direction of the boat.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a first embodiment of the invention.

FIG. 2 is a perspective view of one embodiment of a weight.

FIG. 3 is an elevational view of one embodiment of a weight attached to an anchor line.

FIG. 4A is a front elevational view schematic diagram of a weight.

FIG. 4B is a top plan view schematic diagram of the weight shown in FIG. 4A.

FIG. 4C is a side elevational view schematic diagram of the weight shown in FIG. 4A.

FIG. 4D is a bottom plan view schematic diagram of the weight shown in FIG. 4A.

FIG. 4E is a schematic diagram of a clevis pin and a cotter pin.

FIG. 5 is a side elevational view schematic diagram of a weight with an attachment mechanism.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

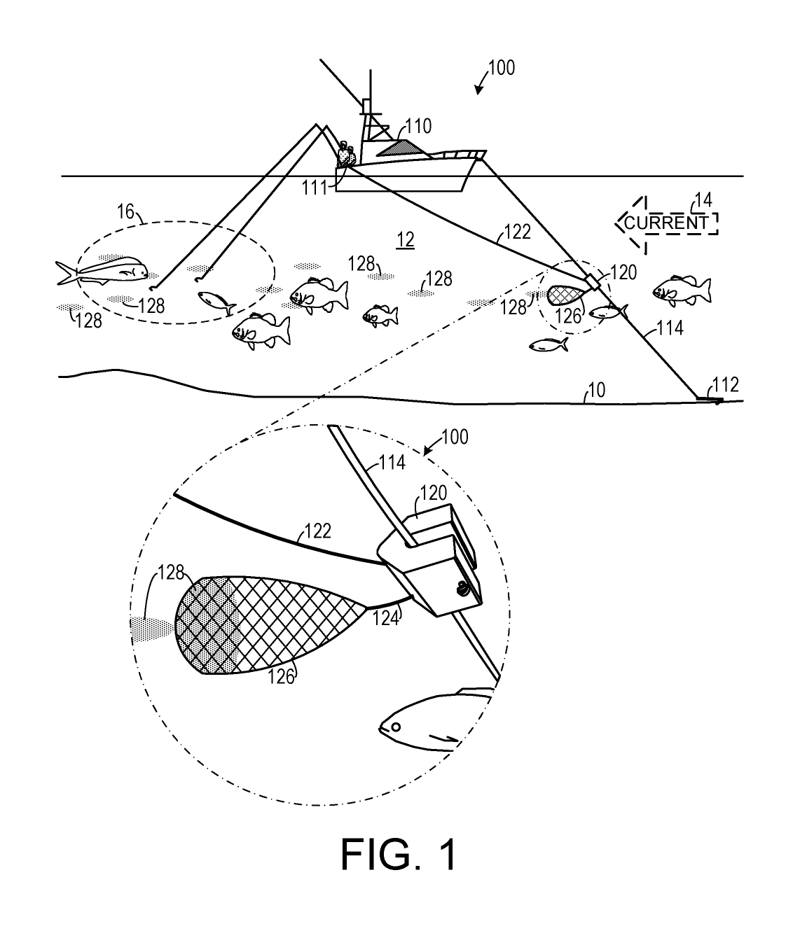

As shown in FIG. 1, one embodiment of a fishing apparatus 100 includes a boat 110 that is secured to a floor 10 of a body of water 12 by an anchor 112. The anchor 112 is secured to the boat 110 by an anchor line 114. Typically, a current 14 in the body of water 12 drives the boat driven to a down-current position from the anchor 112. A weight 120 is secured to the anchor line 114 and a chumming device 126 (which can be a chum bag—such as a net bag, a metal or plastic chum container or and device capable of holding and gradually dispersing chum) is attached to the weight 120 with an attachment device 124 (for example, with a line, a chain or the like). The chumming device 126 holds chum 128 therein and disperses the chum 128 when the chumming device 126 is in the water 12. The weight 120 can be made from materials such as cast aluminum, brass, lead, plastics (typically weighted with lead), etc. The weight 120 should be sufficiently heavy to counteract any buoyancy of the loaded chumming device 126 down.

The chum 128 moves down-current from the chumming device 126 toward a desired fish striking zone 16 below the boat 110. A depth line 122 is attached to the weight 120. The depth line 122 is used to lower the weight 120 along the anchor line 114 so that the chumming device 126 is lowered to a desired depth. Once the chumming device 128 reaches the desired depth, the depth line 122 can be secured to a cleat 111 or similar device on the boat. As a result, the current 14 tends to carry the chum 128 in the direction of the boat 110 (which is also pushed down current from the anchor by the current) at the desired depth.

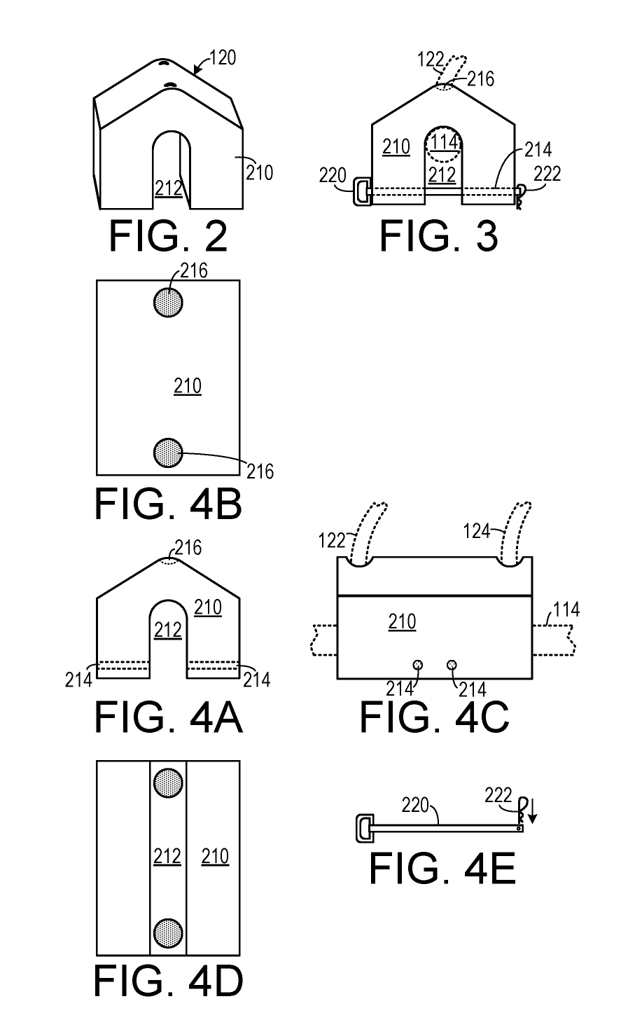

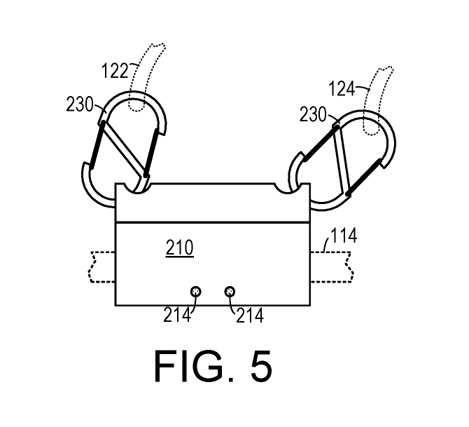

As shown in FIGS. 2, 3 and 4A-4E, one representative embodiment of the weight 120 includes an elongated body portion 210 having a top, an opposite bottom, a first elongated side and an opposite second elongated side. The body portion 210 defines a U-shaped opening 212 along its length that opens to the bottom. The U-shaped opening 212 has a width that is sufficient to allow the anchor line 114 to pass there-through. The body portion 210 defines two spaced apart holes 216 that pass through the top of the body portion 210 and that open into the U-shaped opening 212. One of the holes 216 is configured for attaching the depth line 122 to the weight 120 and the other hole 216 is configured for attaching the chumming device attachment device 124 to the weight 120. The elongated body portion 122 also defines at least one passage 214 (two passages in some embodiments) that passes from the first side through the second side and configured to receive a clevis pin 220. The clevis pin 220 is configured to hold a portion of the anchor line 114 within the U-shaped opening 212 and is secured with a cotter pin 222. (As will be readily appreciated, many other mechanisms may be used to hold the anchor line within the U-shaped groove 212 in the weight 120.) As shown in FIG. 5, in one embodiment, two-sided carabiners 230 can be used to secure the depth line 122 a chumming device 124 to the body portion 210.

Many other embodiments of the weight may be employed. For example, in one embodiment, the weight may include two weighed halves that form a generally cylindrical body with tapered ends. The weight may be configured to have an aperture extending through the generally cylindrical body for receiving an anchor line. The weight may also have a through hole disposed thereon for receiving a depth line. The chum weight may also have an attachment bar for attaching a chum bag filled with chum bait to the weight. The chum weight may be designed to easily clamp around an anchor line.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A chum sink for use with an anchor line extending from a boat to an anchor, comprising:
(a) a weight that is selectively attachable to the anchor line;
(b) a chumming device attached to the weight, the chumming device configured to hold chum therein and to disperse chum when the chumming device is in water; and
(c) a depth line that is attached to the weight, the depth line configured to lower the weight along the anchor line so that the chumming device is lowered to a desired depth, so that the chumming device is held by the weight up-current from the boat at the desired depth and so that the chumming device disperses chum at the desired depth in the water and so that dispersed chum is carried down-current in the direction of the boat.

2. The chum sink of claim 1, wherein the chumming device comprises a bag into which the chum is placed and that defines a plurality of openings out of which the chum passes.

3. The chum sink of claim 1, wherein the weight comprises:
(a) an elongated body portion having a top, an opposite bottom, a first elongated side and an opposite second elongated side, the body portion defining a U-shaped opening along its length that opens to the bottom, the U-shaped opening having a width that is sufficient to allow the anchor line to pass there-through, the body portion defining two spaced apart holes that pass through the top of the body portion and open into the U-shaped opening, one of which is configured for attaching the weight to the depth line, the other of which is configured for attaching the chumming device to the weight, elongated body portion also defining at least one passage that passes from the first side through the second side and configured to receive a clevis pin there-through; and
(b) a clevis pin that is configured to hold a portion of the anchor line within the U-shaped opening and to be secured therein with a cotter pin.

4. The chum sink of claim 1, further comprising an attachment device for attaching the chumming device to the weight.

5. The chum sink of claim 4, wherein the attachment device comprises a two-sided carabiner.

6. The chum sink of claim 1, further comprising an attachment device for attaching the depth line to the weight.

6. m sink of claim 6, wherein the attachment device comprises a two-sided carabiner.

8. A fishing apparatus, comprising:
(a) a boat secured to a floor of a body of water by an anchor that is secured to the boat by an anchor line, the boat driven to a down-current position from the anchor by a current in the body of water;
(b) a weight that is secured to the anchor line;
(c) a chumming device that is attached to the weight, the chumming device configured to hold chum therein and to disperse chum when the chumming device is in the water so that the chum moves down-current from the chumming device toward and area below the boat; and
(d) a depth line that is attached to the weight, the depth line configured to lower the weight along the anchor line so that the chumming device is lowered to a desired depth.

9. The fishing apparatus of claim 8, wherein the chumming device comprises a bag into which the chum is placed and that defines a plurality of openings out of which the chum passes.

10. The fishing apparatus of claim 8, wherein the weight comprises:
(a) an elongated body portion having a top, an opposite bottom, a first elongated side and an opposite second elongated side, the body portion defining a U-shaped opening along its length that opens to the bottom, the U-shaped opening having a width that is sufficient to allow the anchor line to pass there-through, the body portion defining two spaced apart holes that pass through the top of the body portion and open into the U-shaped opening, one of which is configured for attaching the weight to the depth line, the other of which is configured for attaching the chumming device to the weight, elongated body portion also defining at least one passage that passes from the first side through the second side and configured to receive a clevis pin there-through; and
(b) a clevis pin that is configured to hold a portion of the anchor line within the U-shaped opening and to be secured therein with a cotter pin.

11. The fishing apparatus of claim 8, further comprising an attachment device for attaching the chumming device to the weight.

12. The fishing apparatus of claim 11, wherein the attachment device comprises a two-sided carabiner.

13. The fishing apparatus of claim 8, further comprising an attachment device for attaching the depth line to the weight.

14. The fishing apparatus of claim 13, wherein the attachment device comprises a two-sided carabiner.

15. A method of dispersing chum in water from an anchor line attached to an anchor and extending from a boat in water, comprising the steps of:
(a) placing the chum in a chumming device;
(b) attaching a weight to the anchor line
(c) attaching the chumming device to the weight;
(d) lowering the weight and the chumming device along the anchor line to a desired depth so that chum is dispersed from the chumming device at the desired depth and so that the chum moves down-current from the chumming device in a direction of the boat.

16. The method of claim 15, wherein the step of attaching a weight to the anchor line comprises the steps of:
(a) passing the anchor line through a U-shaped opening defined by the weight;
(b) holding the anchor line in the U-shaped opening by passing a clevis pin through a passage passing transversely through the weight; and
(c) securing the clevis pin in the passage with a cotter pin.

17. The method of claim 15, wherein the chumming device comprises a chum bag.

18. The method of claim 15, wherein the step of lowering the weight comprises the steps of:
(a) playing out a depth line affixed to the weight until the weight is at the desired depth; and
(b) affixing the depth line to a cleat to maintain the weight at the desired depth.
